(19) United States
(12) Patent Application Publication
(10) Pub. No.: US 2026/0276294 A1
(43) Pub. Date: Sep. 17, 2026

(54) REFRIGERATOR

(71) Applicant: Samsung Electronics Co., Ltd., Suwon-si (KR)

(72) Inventors: Seungjin LEE, Suwon-si (KR); Taehyun SUNG, Suwon-si (KR); Jaebok LEE, Suwon-si (KR); Dongpil SEO, Suwon-si (KR)

(21) Appl. No.: 19/669,364

(22) Filed: May 6, 2026

Related U.S. Application Data
(63) Continuation of application No. PCT/KR2024/017710, filed on Nov. 11, 2024.

(30) Foreign Application Priority Data
Jan. 5, 2024 (KR) 10-2024-0002508
Apr. 12, 2024 (KR) 10-2024-0049655

(51) Int. Cl. F25D 23/02; E05D 11/00; F25D 15/00; F25D 19/00

(52) U.S. Cl. CPC F25D 23/028; E05D 11/0054; F25D 15/00; F25D 19/00

(57) ABSTRACT

A refrigerator is provided. The refrigerator includes a main body, a storage compartment formed inside the main body, a thermoelectric module assembly including a thermoelectric element including a heat generating portion and a heat absorbing portion, a heat dissipating sink in contact with the heat generating portion, a cooling sink in contact with the heat absorbing portion, and a dissipating duct configured to dissipate heat from the heat dissipating sink, the thermoelectric module assembly being coupled to an upper portion of the main body to cool the storage compartment, and a fastening member configured to pass through the thermoelectric module assembly to be coupled to the upper portion of the main body, the fastening member coupling the thermoelectric module assembly to the upper portion of the upper portion of the main body, wherein the thermoelectric module assembly further includes at least one support rib protruding downwardly.

### CROSS-REFERENCE TO RELATED APPLICATIONS

This application is a continuation application, claiming priority under 35 U.S.C. § 365(c), of an International application No. PCT/KR2024/017710, filed on Nov. 11, 2024, which is based on and claims the benefit of a Korean patent application number 10-2024-0002508, filed on Jan. 5, 2024, in the Ministry of Intellectual Property (MOIP), and of a Korean patent application number 10-2024-0049655, filed on Apr. 12, 2024, in the Ministry of Intellectual Property (MOIP), the disclosure of each of which is incorporated by reference herein in its entirety.

### BACKGROUND

### 1. Field

The disclosure relates to a refrigerator. More particularly, the disclosure relates to a refrigerator having a thermoelectric element for cooling a storage compartment.

### 2. Description of Related Art

A refrigerator is a home appliance for keeping food fresh, including a main body having a storage compartment, a cold air supply device for supplying cold air to the storage compartment.

A thermoelectric element may be used as the cold air supply device of the refrigerator. The thermoelectric element may have a heat generating portion formed on one side and a heat absorbing portion formed on the opposite side. When a current is applied to the thermoelectric element, the heat generating portion may generate heat and the heat absorbing portion may absorb heat.

The refrigerator may include a heat dissipating sink that contacts one side of the thermoelectric element, a cooling sink that contacts the other side of the thermoelectric element, and a dissipating duct for dissipating heat from the heat dissipating sink so that efficiency of a cooling action through the thermoelectric element is increased. The thermoelectric element, the heat dissipating sink, the cooling sink, and the dissipating duct may be integrally assembled to form a thermoelectric module assembly. The thermoelectric module assembly may be coupled to an upper surface of a main body of the refrigerator.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a refrigerator including a thermoelectric module assembly having a thermoelectric element, a heat sink, a cooling sink, and a heat duct.

Another aspect of the disclosure is to provide a refrigerator in which a thermoelectric module assembly is coupled to an upper surface of a main body.

Another aspect of the disclosure is to provide a refrigerator in which a gap between a thermoelectric module assembly and an upper surface of a main body is eliminated or minimized.

Additional aspects will be set forth in part in the description which follows and, in part, will be apparent from the description, or may be learned by practice of the presented embodiments.

In accordance with an aspect of the disclosure, a refrigerator is provided. The refrigerator includes a main body, a storage compartment formed inside the main body, a thermoelectric module assembly including a thermoelectric element including a heat generating portion and a heat absorbing portion, a heat dissipating sink in contact with the heat generating portion, a cooling sink in contact with the heat absorbing portion, and a dissipating duct configured to dissipate heat from the heat dissipating sink, the thermoelectric module assembly being coupled to an upper portion of the main body to cool the storage compartment, and a fastening member configured to pass through the thermoelectric module assembly to be coupled to the upper portion of the main body, the fastening member coupling the thermoelectric module assembly to the upper portion of the main body, wherein the thermoelectric module assembly further includes at least one support rib protruding downwardly to be supported on the upper portion of the main body at a position other than a position at which the fastening member is coupled.

A position of the at least one support rib is further away from a central portion of an upper surface of the main body than a position of the fastening member.

The at least one support rib includes a first support rib protruding from a lower surface of the dissipating duct.

The first support rib is formed on an edge portion of a lower surface of the dissipating duct.

The dissipating duct includes a dissipating duct body, and a dissipating duct cover coupled to an upper portion of the dissipating duct body to form a dissipating flow path therebetween, and the first support rib protrudes from a lower surface of the dissipating duct body.

The dissipating duct body includes a coupling hole through which the fastening member passes, and the first support rib is spaced apart from the coupling hole.

The thermoelectric module assembly includes a heat dissipation fan and a fan case in which the heat dissipation fan is installed.

The at least one support rib includes a second support rib protruding from a lower surface of the fan case.

The thermoelectric module assembly includes a module plate on which the thermoelectric element, the heat dissipating sink, and the cooling sink are installed, and the fan case and the module plate is integrally formed.

The main body includes an inner case forming the storage compartment, an outer case coupled to an outer side of the inner case, and a connection frame disposed between the inner case and the outer case to form a through-hole in which at least a portion of the thermoelectric module assembly is disposed in an upper wall of the main body, and the at least one fastening member pass through the thermoelectric module assembly and the outer case to be coupled to the connection frame.

The refrigerator further includes a cushioning member disposed between the thermoelectric module assembly and an upper surface of the main body.

The cushioning member includes a foam sheet.

The cushioning member is adhered to a lower surface of the dissipating duct.

The refrigerator further includes a door configured to open or close the storage compartment, a hinge configured to couple the door to the main body such that the door is rotatable, and a top cover coupled to an upper surface of the main body to cover the hinge.

The top cover is coupled to the upper surface of the main body such that the top cover presses at least a portion of the thermoelectric module assembly.

In accordance with another aspect of the disclosure, a refrigerator is provided. The refrigerator includes a main body, a storage compartment formed inside the main body, a thermoelectric module assembly including a thermoelectric element having a heat generating portion and a heat absorbing portion, a heat dissipating sink in contact with the heat generating portion, a cooling sink in contact with the heat absorbing portion, and a dissipating duct configured to dissipate heat from the heat dissipating sink, the thermoelectric module assembly being coupled to an upper surface of the main body to cool the storage compartment, a fastening member configured to pass through the thermoelectric module assembly to be coupled to the upper surface of the main body to couple the thermoelectric module assembly thereto, and a cushioning member disposed between the thermoelectric module assembly and the upper surface of the main body.

The cushioning member includes a foam sheet.

The cushioning member is adhered to a lower surface of the dissipating duct.

The thermoelectric module assembly includes at least one support rib protruding downwardly to be to be supported on the upper surface of the main body at a position other than a position at which the fastening member is coupled, and the cushioning member is configured to avoid the at least one support rib.

In accordance with another aspect of the disclosure, a refrigerator is provided. The refrigerator includes a main body, a storage compartment formed inside the main body, a door configured to open or close the storage compartment, a hinge configured to couple the door to the main body such that the door is rotatable, a top cover coupled to an upper surface of the main body to cover the hinge, and a thermoelectric module assembly including a thermoelectric element having a heat generating portion and a heat absorbing portion, a heat dissipating sink in contact with the heat generating portion, a cooling sink in contact with the heat absorbing portion, and a dissipating duct configured to dissipate heat from the heat dissipating sink, the thermoelectric module assembly being coupled to the upper surface of the main body to cool the storage compartment, wherein the top cover is coupled to the upper surface of the main body such that the top cover presses at least a portion of the thermoelectric module assembly.

According to an embodiment of the disclosure, when the thermoelectric module assembly is coupled to the upper surface of the main body, the gap between the thermoelectric module assembly and the upper surface of the main body does not occur or is minimized, thereby preventing play and movement of the thermoelectric module assembly.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a refrigerator according to an embodiment of the disclosure;

FIG. 2 is a view illustrating a state in which doors of a refrigerator are opened according to an embodiment of the disclosure;

FIG. 3 is a schematic side cross-sectional view of a refrigerator according to an embodiment of the disclosure;

FIG. 4 is a cross-sectional view taken along line Ι-Ι of FIG. 2 according to an embodiment of the disclosure;

FIG. 5 is a view illustrating a top cover and a thermoelectric module assembly separated from a main body of a refrigerator according to an embodiment of the disclosure;

FIG. 6 is a view illustrating a dissipating duct cover, a dissipating duct body, an extension duct, and a thermoelectric module according to an embodiment of the disclosure;

FIG. 7 is an exploded view of a thermoelectric module according to an embodiment of the disclosure;

FIG. 8 is a perspective view illustrating a lower surface of a top cover according to an embodiment of the disclosure;

FIG. 9 is a perspective view illustrating a lower surface of a thermoelectric module assembly with extension duct omitted according to an embodiment of the disclosure;

FIG. 10 is a lower perspective view illustrating a dissipating duct cover, a dissipating duct body, and a thermoelectric module according to an embodiment of the disclosure;

FIG. 11 is an enlarged view of portion 'A' of FIG. 9 according to an embodiment of the disclosure;

FIG. 12 is an enlarged view of portion 'B' of FIG. 9 according to an embodiment of the disclosure;

FIG. 13 is an enlarged view of portion 'C' of FIG. 9 according to an embodiment of the disclosure;

FIG. 14 is an enlarged view of portion 'D' of FIG. 9 according to an embodiment of the disclosure;

FIG. 15 is a cross-sectional view taken along line II-II of FIG. 10 according to an embodiment of the disclosure;

FIG. 16 is a cross-sectional view taken along line III-III of FIG. 10 according to an embodiment of the disclosure;

FIG. 17 is a front view of a structure in which a thermoelectric module assembly is coupled to an upper surface of a main body according to an embodiment of the disclosure;

FIG. 18 is a view illustrating a structure in which a cushioning member is provided between a thermoelectric module assembly and an upper surface of a main body according to an embodiment of the disclosure;

FIG. 19 is a view illustrating a top cover separated from a main body of a refrigerator according to an embodiment of the disclosure;

FIG. 20 is a view illustrating a state in which a top cover is coupled to a main body of a refrigerator according to an embodiment of the disclosure;

FIG. 21 is a cross-sectional view taken along line IV-IV of FIG. 20 according to an embodiment of the disclosure;

FIG. 22 is a cross-sectional view taken along line V-V of FIG. 20 according to an embodiment of the disclosure;

FIG. 23 is a cross-sectional view taken along line VI-VI of FIG. 20 according to an embodiment of the disclosure; and

FIG. 24 is a cross-sectional view taken along line VII-VII of FIG. 20 according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the disclosure may include a main body.

The “main body” may include an insulation. The “insulation” may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case. According to an embodiment of the disclosure, the insulation may include a vacuum insulation in addition to a foaming insulation, or may be configured only with a vacuum insulation instead of a foaming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of -20 degrees Celsius to -1 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc. in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data memorized/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, preferred embodiments according to the disclosure will be described in detail with reference to the accompanying drawings.

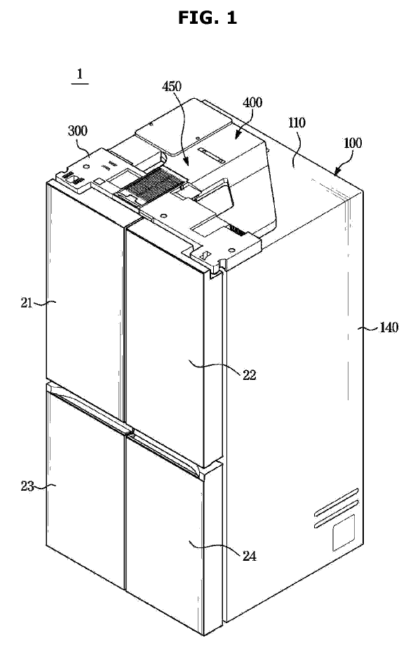

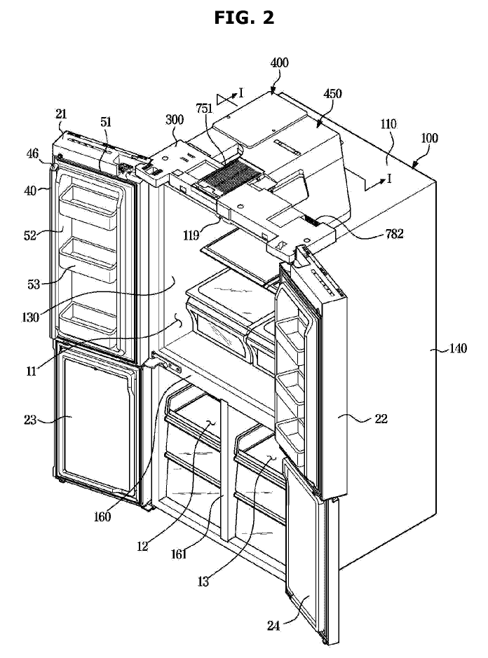

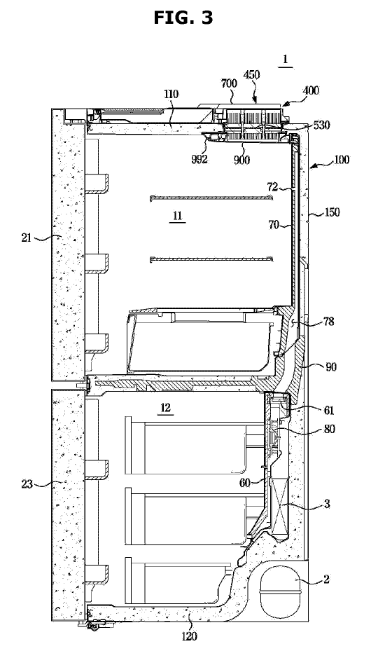

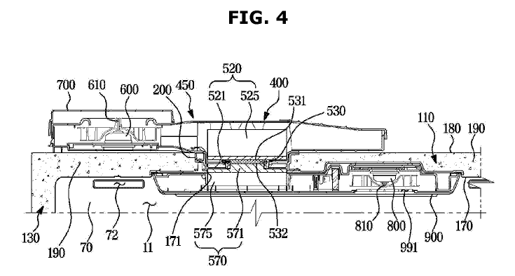

FIG. 1 is a view illustrating a refrigerator according to an embodiment of the disclosure. FIG. 2 is a view illustrating a state in which doors of a refrigerator are opened according to an embodiment of the disclosure. FIG. 3 is a schematic side cross-sectional view of a refrigerator according to an embodiment of the disclosure. FIG. 4 is a cross-sectional view taken along line Ι-Ι of FIG. 2 according to an embodiment of the disclosure.

Referring to FIGS. 1 to 4, a refrigerator 1 may include a main body 100, storage compartments 11, 12, and 13 formed inside the main body 100, and doors 21, 22, 23, and 24 configured to open or close the storage compartments 11, 12, and 13.

The main body 100 may include an inner case 170, an outer case 180 coupled to an outer side of the inner case 170, and an insulation 190 provided between the inner case 170 and the outer case 180. The inner case 170 may form the storage compartments 11, 12, and 13, and the outer case 180 may form an exterior of the main body 100. The insulation 190 may be a urethane foam insulation material.

In another aspect, the main body 100 may include an upper wall 110, a lower wall 120, a left wall 130, a right wall 140, and a rear wall 150. The upper wall 110, the lower wall 120, the left wall 130, the right wall 140, and the rear wall 150 may form an upper surface 111, a lower surface, a left surface, a right surface, and a rear wall of the main body 100, respectively.

The upper wall 110, the lower wall 120, the left wall 130, the right wall 140, and the rear wall 150 may each comprise the inner case 170, the outer case 180, and the insulation 190. In an example, the upper surface 111 of the upper wall 110 may be formed by the outer case 180, a lower surface of the upper wall 110 may be formed by the inner case 170, and the insulation 190 may be provided inside the upper wall 110.

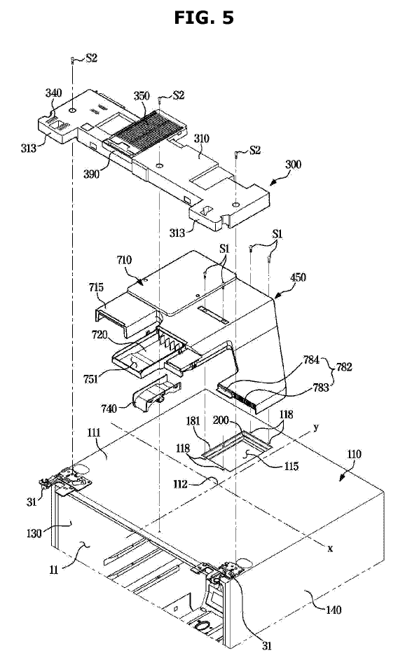

The upper wall 110 may include a through-hole 115 (see FIG. 5). At least a portion of a thermoelectric module assembly 450, which will be described later, may be disposed inside the through-hole 115. The inner case 170 forming the upper wall 110 may have an inner case opening 171 for forming the through-hole 115. The outer case 180 forming the upper wall 110 may have an outer case opening 181 (see FIG. 5) for forming the through-hole 115.

The upper wall 110 may include a connection frame 200 (see FIGS. 4 and 5) disposed between the inner case 170 and the outer case 180. The connection frame 200 may connect the inner case opening 171 and the outer case opening 181, and form the through-hole 115 of the upper wall 110. The connection frame 200 may be formed of a material with a low thermal conductivity. The connection frame 200 may be formed of a resin material.

The storage compartments 11, 12, and 13 may accommodate items. The storage compartments 11, 12, and 13 may be formed to be open at a front side to allow items to be put in or taken out. The main body 100 may include a horizontal partition wall 160 that divides the storage compartments 11, 12, and 13 into an upper first storage compartment 11 and lower storage compartments 12 and 13, and a vertical partition wall 161 that divides the lower storage compartments 12 and 13 into a second storage compartment 12 and a third storage compartment 13. The first storage compartment 11 may be a refrigerating compartment, the second storage compartment 12 may be a freezing compartment, and the third storage compartment 13 may be a variable temperature compartment.

The doors 21, 22, 23, and 24 may open or close the storage compartments 11, 12, and 13. A first door 21 and a second door 22 may open or close the first storage compartment 11, a third door 23 may open or close the second storage compartment 12, and a fourth door 24 may open or close the third storage compartment 13. The doors 21, 22, 23, and 24 may be rotatably coupled to the main body 100.

The doors 21, 22, 23, and 24 may be rotatably coupled to the main body 100 by hinges. For example, the first door 21 and the second door 22 may be rotatably coupled to the main body 100 by a hinge 31 (see FIG. 5) provided on an upper portion of the main body 100 and a hinge provided in a middle of the main body 100, respectively. The hinge 31 may include a hinge pin protruding in a vertical direction to form a rotational axis of the door. The hinge 31 may be covered by a top cover 300 provided to cover a front portion of the upper surface 111 of the main body 100.

One of the first door 21 and the second door 22 may be provided with a rotating bar 40 for covering a gap formed between the first door 21 and the second door 22 when the first door 21 and the second door 22 are closed. The rotating bar 40 may be rotatably provided on one of the first door 21 and the second door 22. The rotating bar 40 may have a rod shape elongated in the vertical direction. The rotating bar 40 may also be referred to as a pillar or a mullion.

A guide protrusion 46 may be provided on an upper end of the rotating bar 40, and a rotation guide 119 for guiding rotation of the guide protrusion 46 may be provided on an upper portion of the main body 100.

Each of the doors 21, 22, 23, and 24 may include a gasket 51. The gasket 51 may be in close contact with a front surface of the main body 100 when the doors 21, 22, 23, and 24 are closed. Each of the doors 21, 22, 23, and 24 may include a dyke 52 protruding rearwardly. A door shelf 53 capable of storing items may be mounted on the dyke 52. The rotating bar 40 may be rotatably mounted on the dyke 52.

Although the number and arrangement of the storage compartments and the number and arrangement of the doors have been described above, there is no limitation on the number and arrangement of the storage compartments and the number and arrangement of the doors of the refrigerator according to an embodiment of the disclosure.

The refrigerator 1 may include a thermoelectric cooling device 400 configured to cool the storage compartment 11.

The thermoelectric cooling device 400 may be provided on an upper side of the storage compartment 11 to cool the storage compartment 11. In other words, the thermoelectric cooling device 400 may be provided on the upper wall 110 of the main body 100.

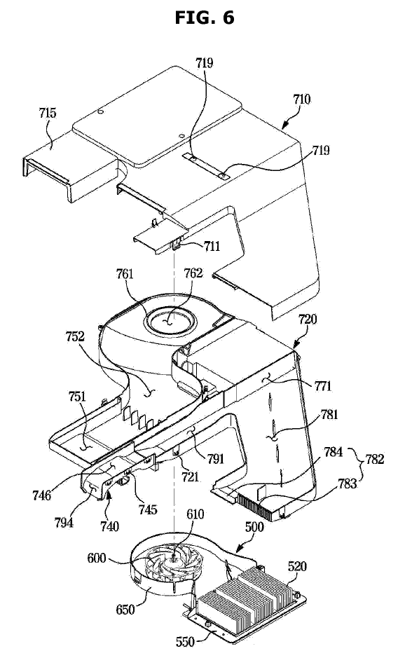

The thermoelectric cooling device 400 may include a thermoelectric module assembly 450. The thermoelectric module assembly 450 may include a thermoelectric module 500 (see FIG. 6) and a dissipating duct 700.

The thermoelectric module 500 and the dissipating duct 700 may be assembled with each other to form the thermoelectric module assembly 450. The thermoelectric module assembly 450 may be coupled to the upper wall 110 of the main body 100 from top to bottom. After the thermoelectric module assembly 450 is coupled to the upper wall 110 of the main body 100 in a direction from top to bottom, a cooling duct 900, which will be described later, may be coupled to a lower surface of the upper wall 110 of the main body 100 from bottom to top.

The thermoelectric module 500 may include a thermoelectric element 530, a heat dissipating sink 520, and a cooling sink 570.

The thermoelectric element 530 may be a semiconductor element that converts thermal energy into electrical energy using the thermoelectric effect, and may also be referred to as a thermoelectric semiconductor element, a Peltier element, or the like.

The thermoelectric element 530 may include a heat generating portion 531 and a heat absorbing portion 532. When a current is applied to the thermoelectric element 530, a heating action (e.g., heat-dissipating) may occur at the heat generating portion 531 and a cooling (e.g., heat-absorbing) action may occur at the heat absorbing portion 532. The thermoelectric element 530 may have a thin hexahedral shape. The heat generating portion 531 may be provided on one surface of the thermoelectric element 530, and the heat absorbing portion 532 may be provided on an opposite surface.

The thermoelectric element 530 may be arranged on the upper wall 110 such that the heat generating portion 531 faces upward of the thermoelectric element 530 and the heat absorbing portion 532 faces downward of the thermoelectric element 530. In other words, the heat generating portion 531 may face an outside of the main body 100, and the heat absorbing portion 532 may face an inside of the storage compartment 11 through the through-hole 115 of the upper wall 110. Thus, air warmed by heat exchange with the heat generating portion 531 may be discharged to the outside of the main body 100, and air cooled by heat exchange with the heat absorbing portion 532 may be supplied to the storage compartment 11 to cool the storage compartment 11.

The thermoelectric module 500 may include the heat dissipating sink 520 in contact with the heat generating portion 531 of the thermoelectric element 530 to efficiently exchange heat between the heat generating portion 531 and air outside the main body 100.

The heat dissipating sink 520 may contact the heat generating portion 531 to absorb heat from the heat generating portion 531 and dissipate heat to the outside of the main body 100. The heat dissipating sink 520 may also be referred to as a heat sink, a hot sink, a heat dissipating sink, a hot heat sink, or the like.

The heat dissipating sink 520 may be formed of a metal material with good thermal conductivity. For example, the heat dissipating sink 520 may be formed of an aluminum or copper.

The heat dissipating sink 520 may include a heat dissipating sink base 521 that contacts the heat generating portion 531, and a plurality of dissipating fins 525 that protrude from the heat dissipating sink base 521 to increase a heat transfer area. The plurality of dissipating fins 525 may protrude upwardly from the heat dissipating sink base 521.

The thermoelectric module 500 may include the cooling sink 570 in contact with the heat absorbing portion 532 to efficiently exchange heat between the heat absorbing portion 532 and air inside the storage compartment 11.

The cooling sink 570 may be positioned on the interior of the storage compartment 11. The cooling sink 570 may cool the storage compartment 11 by taking heat from the storage compartment 11 and transferring the heat to the heat absorbing portion 532. The cooling sink 570 may also be referred to as a cold sink, a chilling sink, a cooling heat sink, a cold heat sink, a chilling heat sink, or the like.

The cooling sink 570 may be formed of a metal material with good thermal conductivity. For example, the cooling sink 570 may be formed of an aluminum or copper.

The cooling sink 570 may include a cooling sink base 571 that contacts the heat absorbing portion 532, and a plurality of cooling fins 575 that protrude from the cooling sink base 571 to increase the heat transfer area. The plurality of cooling fins 575 may protrude downwardly from the cooling sink base 571. The cooling sink base 571 and the plurality of cooling fins 575 may be integrally formed.

The thermoelectric module 500 may include a heat dissipation fan 600 that flows air to efficiently exchange heat between the heat dissipating sink 520 and air outside the main body 100.

The heat dissipation fan 600 may be configured to blow toward the heat dissipating sink 520. The heat dissipation fan 600 may be arranged to be positioned in a horizontal direction of the heat dissipating sink 520. The heat dissipation fan 600 may be provided on the outside of the main body 100. The heat dissipation fan 600 may be arranged on an upper side of the upper wall 110.

The heat dissipation fan 600 may be a centrifugal fan that draws in air in an axial direction and discharges the drawn-in air in a radial direction. The centrifugal fan may include a blower fan. A rotational shaft 610 of the heat dissipation fan 600 may be disposed perpendicular to an upper surface of the upper wall 110.

The dissipating duct 700 may guide air from outside the main body 100 to exchange heat with the heat dissipating sink 520, and may guide the air that has exchanged heat with the heat dissipating sink 520 to be discharged back to the outside of the main body 100.

The heat dissipation fan 600 may be positioned on the interior of the dissipating duct 700. The heat dissipating sink 520 may be positioned inside the dissipating duct 700.

The dissipating duct 700 may include an outside air inlet 751 that draws in air from outside the main body 100 into an interior of the dissipating duct 700, and an outside air outlet 782 that discharges air that has exchanged heat with the heat dissipating sink 520 to the outside of the main body 100.

The thermoelectric cooling device 400 may include a cooling fan 800 that flows air to efficiently exchange heat between the cooling sink 570 and air inside the storage compartment 11. The cooling fan 800 may be disposed inside the cooling duct 900.

The cooling fan 800 may be configured to blow toward the cooling sink 570. The cooling fan 800 may be positioned in a horizontal direction of the cooling sink 570. The cooling fan 800 may be arranged on the interior of the storage compartment 11. The cooling fan 800 may be arranged on a lower side of the upper wall 110.

The cooling fan 800 may be a centrifugal fan that draws in air in an axial direction and discharges the drawn-in air in a radial direction. A rotational shaft 810 of the cooling fan 800 may be disposed perpendicular to a lower surface of the upper wall 110.

The thermoelectric cooling device 400 may include the cooling duct 900 configured to guide air flowing by the cooling fan 800. The cooling duct 900 may guide air from inside the storage compartment 11 to exchange heat with the cooling sink 570, and may guide the air that has exchanged heat with the cooling sink 570 to be discharged back into the inside of the storage compartment 11.

The cooling fan 800 may be positioned inside the cooling duct 900. The cooling sink 570 may pass through an upper surface of the cooling duct 900 and be positioned inside the cooling duct 900. The cooling duct 900 may be coupled to the lower surface of the upper wall 110.

The cooling duct 900 may include an internal air inlet 991 that draws in air from inside the storage compartment 11 into an inside of the cooling duct 900, and an internal air outlet 992 that discharges air that has exchanged heat with the cooling sink 570 into the inside of the storage compartment 11.

The refrigerator 1 may include a refrigeration cycle device for cooling a storage compartment through a refrigeration cycle. The refrigeration cycle device may include a compressor 2, a condenser (not shown), an expansion device (not shown), and an evaporator 3. The evaporator 3 may be provided at a rear side of the storage compartments 12 and 13.

The refrigerator 1 may include evaporator ducts 60 and 70 that guide cold air generated by the evaporator 3. A first evaporator duct 60 may be arranged on a rear side of the second storage compartment 12 and the third storage compartment 13. A second evaporator duct 70 may be arranged on at a rear side of the first storage compartment 11.

Cold air generated by the evaporator 3 may be drawn into an interior of the first evaporator duct 60 by an evaporator fan 80. The cold air drawn into the inside of the first evaporator duct 60 may be discharged to the second storage compartment 12 or the third storage compartment 13 through a cold air outlet (not shown) formed on a front surface. In addition, the cold air drawn into the inside of the first evaporator duct 60 may be guided to an inner flow path 78 of the second evaporator duct 70. The first evaporator duct 60 may be provided with a damper 61 that controls the supply of cold air from the inside of the first evaporator duct 60 to the second evaporator duct 70. A connection duct 90 may be provided between the first evaporator duct 60 and the second evaporator duct 70 to connect the first evaporator duct 60 and the second evaporator duct 70.

The cold air flowing into the inner flow path 78 of the second evaporator duct 70 may be supplied to the first storage compartment 11 through a cold air outlet 72 formed on a front surface of the second evaporator duct 70.

As such, according to an embodiment of the disclosure, the refrigerator may include the thermoelectric cooling device 400 and the refrigeration cycle device, but is not limited thereto, and the refrigerator may include simply the thermoelectric cooling device 400.

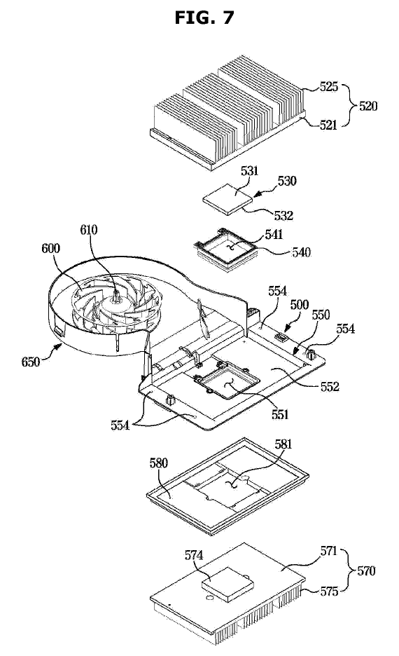

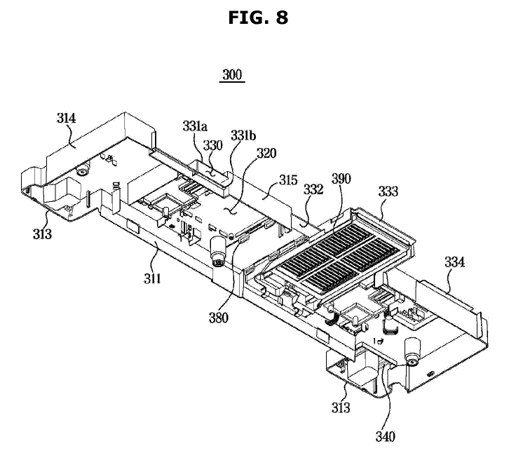

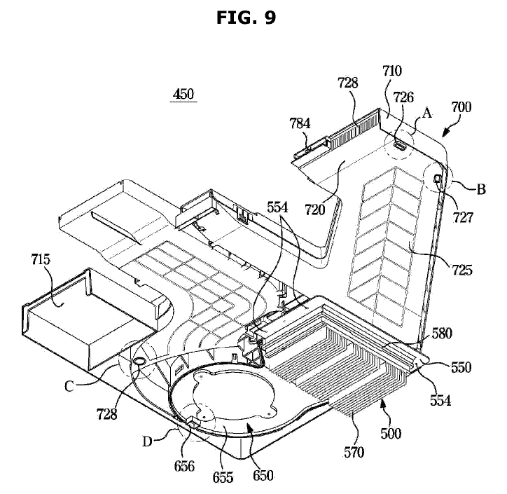

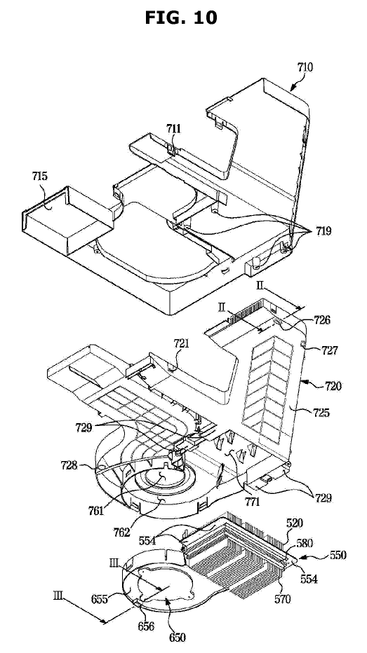

FIG. 5 is a view illustrating a top cover and a thermoelectric module assembly separated from a main body of a refrigerator according to an embodiment of the disclosure. FIG. 6 is a view illustrating a dissipating duct cover, a dissipating duct body, an extension duct, and a thermoelectric module according to an embodiment of the disclosure. FIG. 7 is an exploded view of a thermoelectric module according to an embodiment of the disclosure. FIG. 8 is a perspective view illustrating a lower surface of a top cover according to an embodiment of the disclosure. FIG. 9 is a perspective view illustrating a lower surface of a thermoelectric module assembly with extension duct omitted, according to an embodiment of the disclosure. FIG. 10 is a lower perspective view illustrating a dissipating duct cover, a dissipating duct body, and a thermoelectric module according to an embodiment of the disclosure.

The thermoelectric module 500 may include a module plate 550 on which the thermoelectric element 530, the heat dissipating sink 520, and the cooling sink 570 are installed.

The module plate 550 may serve as a backbone of the thermoelectric module 500. The module plate 550 may be formed of a resin material with low thermal conductivity. The module plate 550 may maintain a gap between the heat dissipating sink 520 and the cooling sink 570, and may support the heat dissipating sink 520 and the cooling sink 570. The module plate 550 may be integrally formed with a fan case 650, which will be described later. However, it is also possible for the module plate 550 to be provided separately from the fan case 650.

The module plate 550 may include a heat dissipating sink support portion 552 that supports the heat dissipating sink 520. The module plate 550 may include a module plate opening 551. The thermoelectric element 530 may be disposed inside the module plate opening 551. The cooling sink 570 may include a cooling conduction portion 574 that protrudes from the cooling sink base 571 for contact with the heat absorbing portion 532 of the thermoelectric element 530.

The thermoelectric module 500 may include an element insulation 540 that thermally insulates the module plate 550 and the thermoelectric element 530. The element insulation 540 may include an element insulation opening 541, and the thermoelectric element 530 may be received in the element insulation opening 541.

The thermoelectric module 500 may include a sink insulation 580 provided between the module plate 550 and the cooling sink 570. The sink insulation 580 may prevent/reduce heat from being transferred between the heat dissipating sink 520 and the cooling sink 570 through the module plate 550. The sink insulation 580 may include a sink insulation opening 581.

The thermoelectric module 500 may include the fan case 650 in which the heat dissipation fan 600 is installed and which guides air blown by the heat dissipation fan 600.

The heat dissipation fan 600 may be a centrifugal fan, and the rotational shaft 610 of the heat dissipation fan 600 may be perpendicular to the bottom of the fan case 650. The heat dissipation fan 600 may be arranged such that the heat dissipating sink 520 is positioned in one radial direction of the heat dissipation fan 600. With such a structure, a length in the vertical direction of the entire thermoelectric module assembly 450 may be compact.

The dissipating duct 700 may include a dissipating duct body 720, a dissipating duct cover 710, and an extension duct 740.

The dissipating duct body 720 may be provided on an upper side of the thermoelectric module 500 to cover the heat dissipation fan 600 and the heat dissipating sink 520. The outside air inlet 751 may be formed on an upper surface of a front portion of the dissipating duct body 720, and the outside air inlet 751 may be covered by a top cover 300, which will be described later.

The dissipating duct cover 710 may be coupled to an upper portion of the dissipating duct body 720 to cover an upper side of the dissipating duct body 720. To this end, the dissipating duct cover 710 may be provided with a duct cover coupling portion 711, and the dissipating duct body 720 may be provided with a duct body coupling portion 721 coupled to the duct cover coupling portion 711. The duct cover coupling portion 711 and the duct body coupling portion 721 may be coupled in a hooked or snapped manner. The dissipating duct cover 710 may include a cover extension portion 715 extending from one side of the dissipating duct cover 710 toward the top cover 300.

The extension duct 740 may be provided in front of the dissipating duct body 720 so as to be connected to the dissipating duct body 720. The extension duct 740 may be formed separately from the dissipating duct body 720. However, alternatively, the extension duct 740 may also be integrally formed with the dissipating duct body 720.

The extension duct 740 may be disposed below the top cover 300 and may be coupled to a lower portion of the top cover 300. To this end, the extension duct 740 may be provided with an extension duct coupling portion 745, and the top cover 300 may be provided with a top cover coupling portion 380 coupled to the extension duct coupling portion 745. The extension duct coupling portion 745 and the top cover coupling portion 380 may be coupled in a hooked or snapped manner. An upper side of the extension duct 740 may be covered by the top cover 300.

The dissipating duct 700 may include outside air outlets 782 and 794 that discharge air that has exchanged heat with the heat dissipating sink 520 to the outside of the main body 100.

The dissipating duct body 720 may include a first outside air outlet 782 that discharges air that has exchanged heat with the heat dissipating sink 520 to the outside of the main body 100.

The first outside air outlet 782 may include a connector 784 configured to guide air from an inside of the dissipating duct 700 to a top cover inner space 320 of the top cover 300. The air discharged through the connector 784 may enter the top cover inner space 320 via a top cover inlet 330.

The first outside air outlet 782 may include an outside outlet 783 partitioned from the connector 784 so as to discharge air from the dissipating duct 700 to an outside of the top cover 300. The outside outlet 783 may have a grille formed therein to prevent foreign matter from entering the inside of the dissipating duct 700 through the outside outlet 783.

The extension duct 740 may include a second outside air outlet 794 that discharges air that has exchanged heat with the heat dissipating sink 520 toward the rotating bar 40. By discharging the air that has exchanged heat with the heat dissipating sink 520 toward the rotating bar 40, condensation may be prevented from occurring on the rotating bar 40.

However, the dissipating duct 700 may not be required to include both the first outside air outlet 782 and the second outside air outlet 794 described above, and the second outside air outlet 794 may be omitted. Further, the first outside air outlet 782 of the dissipating duct 700 may not be required to include both the connector 784 and the outside outlet 783, and the first outside air outlet 782 may include simply the outside outlet 783.

The dissipating duct body 720 may be formed with a fan receiving space 762 that receives the heat dissipation fan 600. The fan receiving space 762 may be formed on a lower surface of the dissipating duct body 720. The dissipating duct body 720 may include a fan inlet 761 through which air flows into the fan receiving space 762.

The dissipating duct body 720 may include a sink receiving space 771 formed on a downstream side of the fan receiving space 762 to receive the heat dissipating sink 520.

The dissipating duct body 720 may include an intake space 752 formed on an upper surface of the dissipating duct body 720 so as to guide air drawn in through the outside air inlet 751 into the fan receiving space 762. An upper side of the intake space 752 may be formed to be open, and the open upper side of the intake space 752 may be covered by the dissipating duct cover 710. The intake space 752 may be formed on an upstream side of the fan receiving space 762. The intake space 752 may be connected to the fan receiving space 762 via the fan inlet 761.

The dissipating duct body 720 may include a first discharge space 781 formed on the upper surface of the dissipating duct body 720 so as to guide air that has exchanged heat with the heat dissipating sink 520 to the first outside air outlet 782. An upper side of the first discharge space 781 may be open, and the open upper side of the first discharge space may be covered by the dissipating duct cover 710. The first discharge space 781 may be formed on a downstream side of the sink receiving space 771.

The dissipating duct body 720 may include a second discharge space 791 formed on the upper surface of the dissipating duct body 720 to guide air that has exchanged heat with the heat dissipating sink 520 to the second outside air outlet 794. An upper side of the second discharge space 791 may be open, and the open upper side of the second discharge space 791 may be covered by the dissipating duct cover 710. The second discharge space 791 may be formed on a downstream side of the sink receiving space 771.

The extension duct 740 may include an extension discharge space 746 connected to the second discharge space 791 of the dissipating duct body 720. Air in the second discharge space 791 may be guided to the second outside air outlet 794 through the extension discharge space 746.

The thermoelectric module 500 and the dissipating duct 700 may be assembled to form the thermoelectric module assembly 450, and the thermoelectric module assembly 450 may be coupled to the upper surface 111 of the upper wall 110 of the main body 100. In this case, a portion of the thermoelectric module assembly 450 may be disposed inside the through-hole 115 of the upper wall 110.

The thermoelectric module assembly 450 may be coupled to the upper wall 110 of the main body 100 by at least one fastening member S1 (see FIG. 5). The at least one fastening member S1 may be a mechanical element for coupling, such as a screw, bolt, or the like.

The at least one fastening member S1 may be coupled to the upper wall 110 of the main body 100 by passing through the thermoelectric module assembly 450.

According to an embodiment, the at least one fastening member S1 may pass through the dissipating duct cover 710, the dissipating duct body 720, and the module plate 550 and be coupled to the upper wall 110 of the main body 100. To this end, a coupling hole 719 may be formed in the dissipating duct cover 710, a coupling hole 729 may be formed in the dissipating duct body 720, and a coupling hole 554 may be formed in the module plate 550 (see FIG. 10).

A coupling hole 118, to which the at least one fastening member S1 is coupled, may be formed in the upper wall 110 of the main body 100. The at least one fastening member S1 may pass through the thermoelectric module assembly 450 and be coupled to the connection frame 200 of the upper wall 110.

The at least one fastening member S1 may be coupled near a central portion of the thermoelectric module assembly 450 in a left-right direction.

The refrigerator 1 may include the top cover 300 coupled to a front portion of the upper surface 111 of the main body 100 to cover the plurality of hinges 31. The top cover 300 may be coupled to the upper wall 110 of the main body 100 using at least one fastening member S2. After the thermoelectric module assembly 450 is coupled to the upper wall 110 of the main body 100, the top cover 300 may be coupled to the upper wall 110 of the main body 100.

The top cover 300 may include a top cover upper surface portion 310, a top cover front portion 311 extending downwardly from a front edge of the top cover upper surface portion 310, a top cover side portion 314 extending downwardly from both side edges of the top cover upper surface portion 310, a top cover rear portion 315 extending downwardly from a rear edge of the top cover upper surface portion 310, and the top cover inner space 320 formed by the top cover upper surface portion 310, the top cover front portion 311, the top cover side portion 314, and the top cover rear portion 315. A lower side of the top cover inner space 320 may be open, and the open lower side of the top cover inner space 320 may be covered by the upper surface 111 of the upper wall 110.

The top cover 300 may include front protrusions 313 protruding forwardly from both side ends of the top cover to cover the plurality of hinges 31.

The thermoelectric cooling device 400 may include a dust filter 390 configured to filter out foreign matter from air entering the outside air inlet 751. The dust filter 390 may be slidably mounted to the top cover 300 in a front-rear direction.

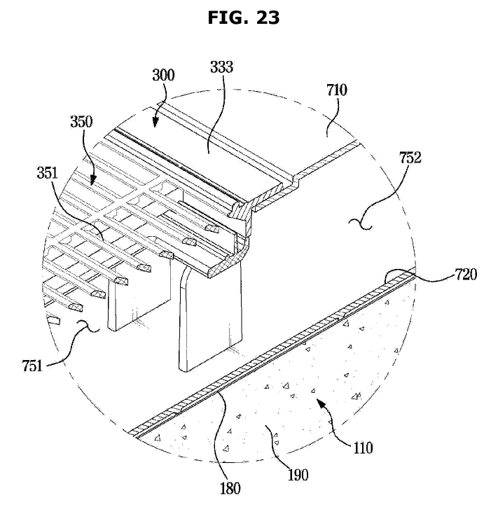

The top cover 300 may include an intake grille portion 350 formed on the top cover upper surface portion 310. The intake grille portion 350 may include a plurality of grille ribs 351 (see FIG. 23) spaced apart from each other. The intake grille portion 350 may be positioned on an upper side of the dust filter 390. The intake grille portion 350 may primarily block foreign matter from being drawn into the interior of the dissipating duct 700 prior to the dust filter 390. The intake grille portion 350 may protect the dust filter 390 by preventing an external force from being applied to the dust filter 390.

At least a portion of the air exiting the dissipating duct 700 via the first outside air outlet 782 may enter the top cover inner space 320. In other words, air warmed by heat exchange with the heat dissipating sink 520 may enter the top cover inner space 320. To this end, the top cover 300 may be formed with the top cover inlet 330. The top cover inlet 330 may be formed in the top cover rear portion 315.

The air introduced into the top cover inner space 320 may pass through the top cover inner space 320 and be discharged to an outside of the top cover 300. To this end, the top cover 300 may include a top cover outlet 340. The top cover outlet 340 may be formed in the front protrusion 313 of the top cover 300.

As such, air that has exchanged heat with the heat dissipating sink 520 may heat the upper surface 111 of the main body 100 as it passes through the top cover inner space 320. Thus, the occurrence of condensation on an upper front portion of the main body 100 may be prevented.

At least a portion of the top cover 300 may be disposed to overlap the dissipating duct 700. At least a portion of the top cover 300 may be disposed on an upper side of the dissipating duct 700 such that it overlaps with the dissipating duct 700.

In other words, the top cover 300 may be coupled to the upper surface 111 of the main body 100 such that the top cover 300 presses against at least a portion of the thermoelectric module assembly 450. To this end, the top cover 300 may include a pressing portion 331a, 331b, 332, 333 and 334 configured to press the thermoelectric module assembly 450. The pressing portion 331a, 331b, 332, 333 and 334 may be formed to protrude rearwardly. The pressing portion 331a, 331b, 332, 333 and 334 may press a front end portion of the thermoelectric module assembly 450 downwardly. The pressing portions will be described further below.

Referring to FIGS. 9 and 10, as described above, the thermoelectric module assembly 450 may be coupled to the upper wall 110 of the main body 100 via the at least one fastening member S1.

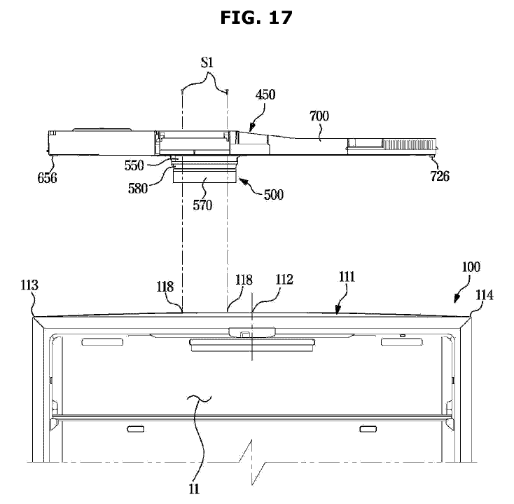

However, the main body 100 may be formed by filling a liquid foaming agent between the inner case 170 and the outer case 180 and foaming the same, and the shape of the outer case 180 may be deformed during or after the foaming of the foaming agent. In other words, depending on the foaming process, the outer case 180 may be deformed to be convex outward (e.g., bulging phenomenon). In an example, a central portion 112 of the upper surface 111 of the main body 100 may protrude upwardly (see FIG. 17).

As a result, other portions of the thermoelectric module assembly 450 may be spaced away from the upper surface 111 of the main body 100, except for a portion to which the at least one fastening member S1 is coupled, resulting in a gap (e.g., lifting phenomenon). In particular, the gap between the thermoelectric module assembly 450 and the upper surface 111 of the main body 100 may be greater toward both end portions 113 and 114 of the upper surface 111 of the main body 100.

As such, a gap generated between the thermoelectric module assembly 450 and the upper surface 111 of the main body 100 may cause the thermoelectric module assembly 450 to float instead of being fixed. Furthermore, noise may be generated due to collision of the thermoelectric module assembly 450 with the main body 100.

To prevent a gap from occurring between the thermoelectric module assembly 450 and the upper surface 111 of the main body 100 due to the bulging phenomenon caused by the foaming process as described above, and to fix the thermoelectric module assembly 450, the thermoelectric module assembly 450 according to an embodiment of the disclosure may include at least one support rib 656, 726, 727 and 728 protruding downwardly at a position other than a position where the at least one fastening member S1 is coupled. The at least one support rib 656, 726, 727 and 728 may protrude downwardly from one surface of the thermoelectric module assembly 450 to be supported on the upper surface 111 of the main body 100.

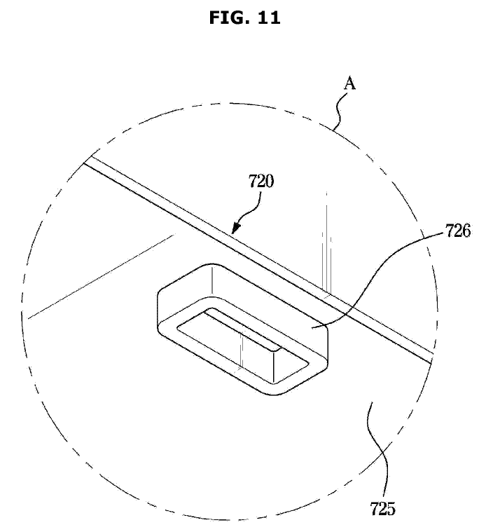

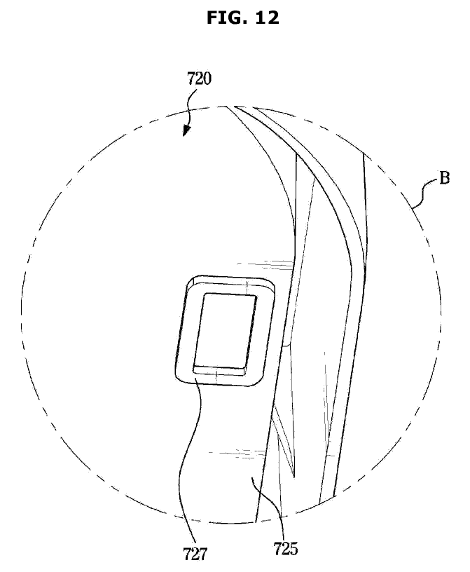

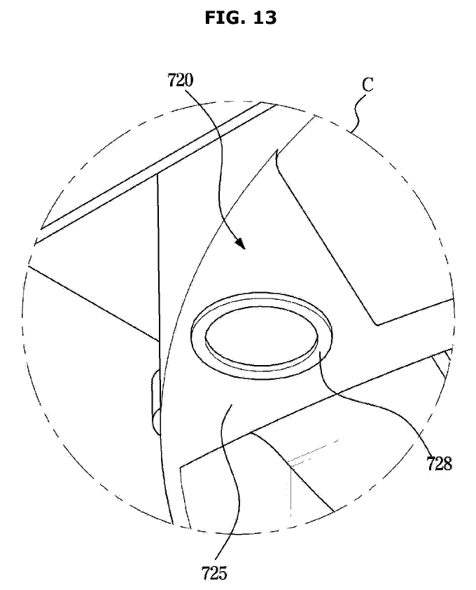

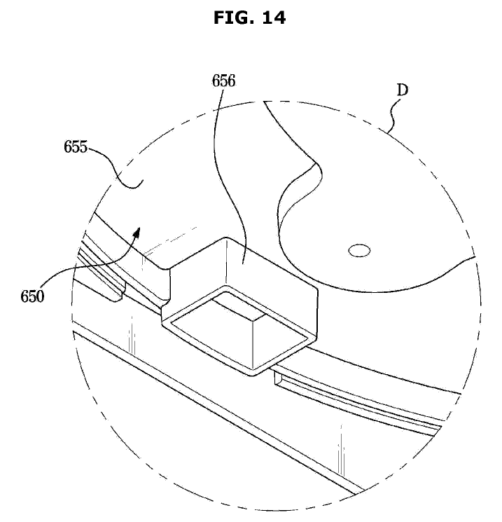

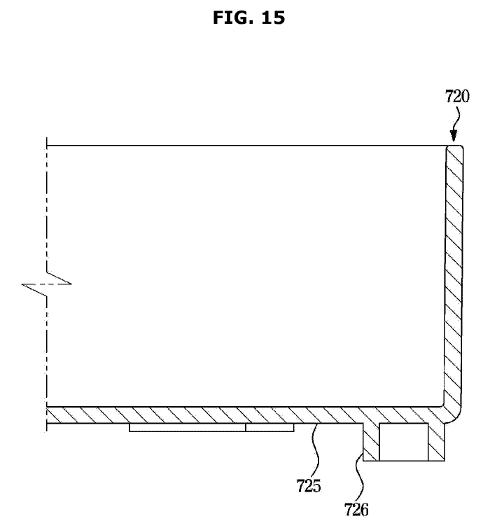

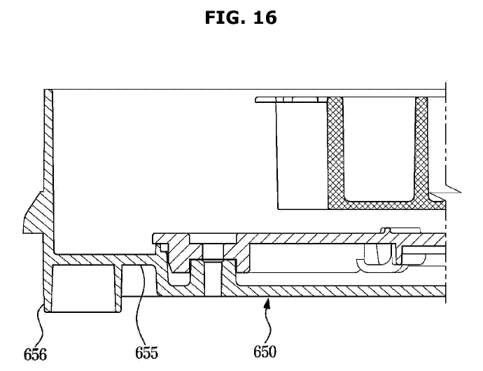

FIG. 11 is an enlarged view of portion 'A' of FIG. 9 according to an embodiment of the disclosure. FIG. 12 is an enlarged view of portion 'B' of FIG. 9 according to an embodiment of the disclosure. FIG. 13 is an enlarged view of portion 'C' of FIG. 9 according to an embodiment of the disclosure. FIG. 14 is an enlarged view of portion 'D' of FIG. 9 according to an embodiment of the disclosure. FIG. 15 is a cross-sectional view taken along line II-II of FIG. 10 according to an embodiment of the disclosure. FIG. 16 is a cross-sectional view taken along line III-III of FIG. 10 according to an embodiment of the disclosure. FIG. 17 is a front view of a structure in which a thermoelectric module assembly is coupled to an upper surface of a main body according to an embodiment of the disclosure.

The at least one support rib 656, 726, 727 and 728 may be disposed at a position further away from the central portion 112 (see FIGS. 5 and 17) of the upper surface 111 of the main body 100 in the left-right direction (x) and the front-rear direction (y) than the position of the at least one fastening member S1.

The at least one support rib 656, 726, 727 and 728 may include at least one first support rib 726, 727 and 728 protruding from the lower surface of the dissipating duct 700.

Specifically, the at least one first support rib 726, 727 and 728 may protrude from a lower surface 725 of the dissipating duct body 720.

The at least one first support rib 726, 727 and 728 may be formed on an edge portion of the lower surface 725 of the dissipating duct body 720. As such, the thermoelectric module assembly 450 may be more effectively fixed by having the at least one first support rib 726, 727 and 728 formed on the edge portion of the lower surface 725 of the dissipating duct body 720.

The at least one first support rib 726, 727 and 728 may be spaced apart from the coupling hole 729 formed in the dissipating duct body 720 for the fastening member S1 to penetrate.

The at least one first support rib 726, 727 and 728 may include first support ribs 726 and 727 located on a right side of the central portion 112 of the upper surface 111 of the main body 100, and a first support rib 728 located on a left side of the central portion 112 of the upper surface 111 of the main body 100. The plurality of first support ribs may be located on both sides of the central portion 112 of the upper surface 111 of the main body 100, so that the thermoelectric module assembly 450 may be more reliably supported and fixed.

The at least one support rib 656, 726, 727 and 728 may include at least one second support rib 656 protruding from a lower surface 655 of the fan case 650. The at least one second support rib 656 may be formed on an edge portion of the lower surface 655 of the fan case 650. The at least one second support rib 656 may be located on one side of the central portion 112 of the upper surface 111 of the main body 100.

The first support rib 728 may be closer to one end portion 113 of the upper surface 111 of the main body 100 than the position of the at least one fastening member S1. The second support rib 656 may be closer to the opposite end portion 114 of the upper surface 111 of the main body 100 than the position of the at least one fastening member S1.

While the accompanying drawings show four support ribs being provided, there is no limitation on the number of support ribs. In addition, there is no limitation on a position and shape of the at least one support rib.

As such, the thermoelectric module assembly 450 may be supported on the upper surface 111 of the main body 100 by the at least one support rib 656, 726, 727 and 728 at a position other than the position where the fastening member S1 is coupled, so that the thermoelectric module assembly 450 may be reliably fixed despite deformation of the upper surface 111 of the main body 100 due to the foaming process.

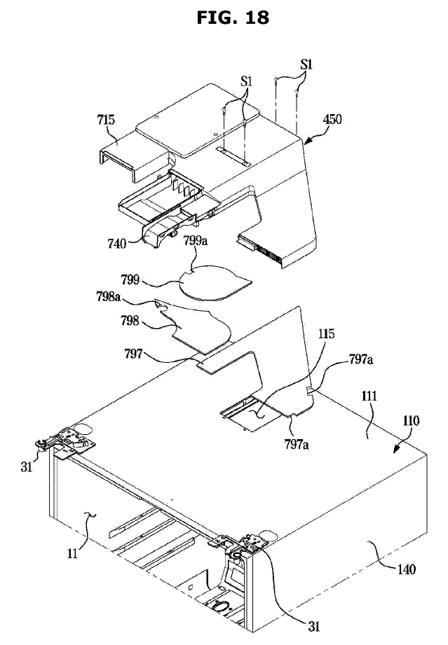

FIG. 18 is a view illustrating a structure in which a cushioning member is provided between a thermoelectric module assembly and an upper surface of a main body according to an embodiment of the disclosure.

Referring to FIG. 18, the refrigerator 1 may include at least one cushioning member 797, 798 and 799 disposed between the thermoelectric module assembly 450 and the upper surface 111 of the main body 100 to prevent a gap from being generated between the thermoelectric module assembly 450 and the upper surface 111 of the main body 100 and to fix the thermoelectric module assembly 450.

The at least one cushioning member 797, 798 and 799 may include a foam sheet. The foam sheet may be a soft foam having a foam structure. The foam sheet may be elastic to fill a gap between a lower surface of the thermoelectric module assembly 450 and the upper surface 111 of the main body 100 and prevent play and movement of the thermoelectric module assembly 450. However, the cushioning member is not limited to a foam sheet and may include a variety of members capable of eliminating the gap between the thermoelectric module assembly 450 and the main body 100 and mitigating impact.

One surface of the at least one cushioning member 797, 798 and 799 may be configured to have tackiness or adhesiveness. Thus, the at least one cushioning member 797, 798 and 799 may be adhered to the lower surface 725 of the dissipating duct body 720 or the lower surface 655 of the fan case 650.

The at least one cushioning member 797, 798 and 799 may include at least one first cushioning member 797, 798 adhered to the lower surface 725 of the dissipating duct body 720. The at least one cushioning member 797, 798 and 799 may include at least one second cushioning member 799 adhered to the lower surface 655 of the fan case 650. Although the first cushioning members 797 and 798 and the second cushioning member 799 are shown in the accompanying drawings as being formed separately, the disclosure is not limited thereto, and the first cushioning members 797 and 798 and the second cushioning member 799 may be integrally formed.

According to an embodiment, when the at least one cushioning member 797, 798 and 799 is provided between the thermoelectric module assembly 450 and the upper surface 111 of the main body 100, the thermoelectric module assembly 450 may not be provided with the at least one support rib described above.

According to an embodiment, the at least one cushioning member 797, 798 and 799 may be provided between the thermoelectric module assembly 450 and the upper surface 111 of the main body 100, and the at least one support rib 656, 726, 727 and 728 may also be provided on the thermoelectric module assembly 450. In this case, the at least one cushioning member 797, 798 and 799 may be formed with an avoidance portion 797a, 798a and 799a through which the at least one support rib 656, 726, 727 and 728 passes. The avoidance portions 797a, 798a and 799a may be formed by cutting a portion of the at least one cushioning member 797, 798 and 799.

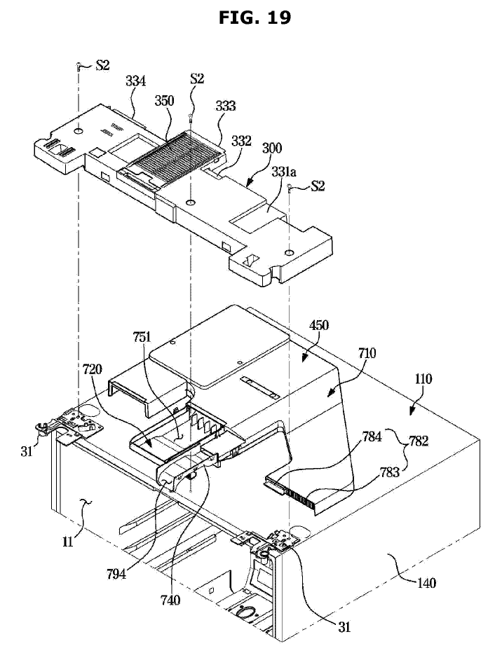

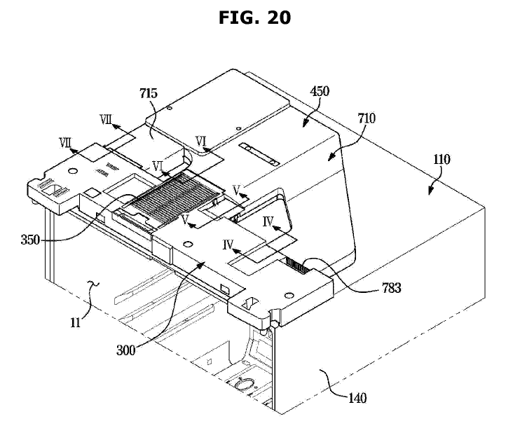

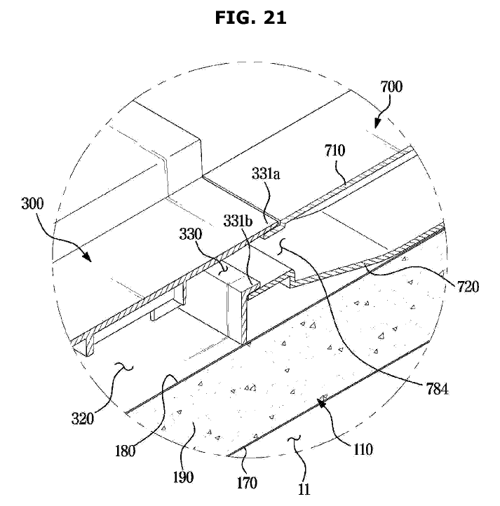

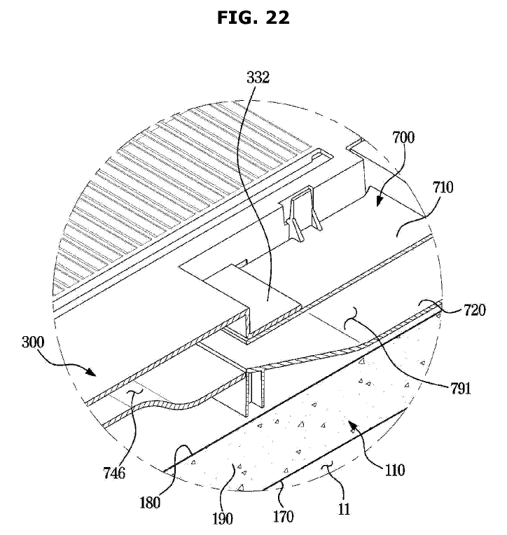

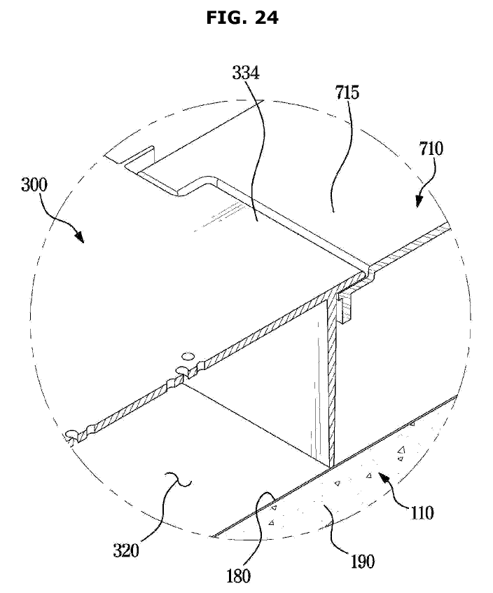

FIG. 19 is a view illustrating a top cover separated from a main body of a refrigerator according to an embodiment of the disclosure. FIG. 20 is a view illustrating a state in which a top cover is coupled to a main body of a refrigerator according to an embodiment of the disclosure. FIG. 21 is a cross-sectional view taken along line IV-IV of FIG. 20 according to an embodiment of the disclosure. FIG. 22 is a cross-sectional view taken along line V-V of FIG. 20 according to an embodiment of the disclosure. FIG. 23 is a cross-sectional view taken along line VI-VI of FIG. 20 according to an embodiment of the disclosure. FIG. 24 is a cross-sectional view taken along line VII-VII of FIG. 20 according to an embodiment of the disclosure.

Referring to FIGS. 19 to 24, as described above, the top cover 300 according to an embodiment of the disclosure may be coupled to the upper wall 110 of the main body 100 after the thermoelectric module assembly 450 is coupled to the upper wall 110 of the main body 100, and the top cover 300 may press downwardly on at least a portion of the thermoelectric module assembly 450.

The top cover 300 may include at least one pressing portion configured to press the thermoelectric module assembly 450. The at least one pressing portion may be formed to protrude rearwardly and may press downwardly on a front end portion of the thermoelectric module assembly 450.

Specifically, as shown in FIG. 21, the at least one pressing portion may include first pressing portions 331a, 331b capable of pressing downwardly on the dissipating duct 700 near the connector 784. The first pressing portion 331a may press downwardly on one front end portion of the dissipating duct cover 710 forming the connector 784. The first pressing portion 331b may press downwardly on one front end portion of the dissipating duct body 720 forming the connector 784.

As shown in FIG. 22, the at least one pressing portion may include a second pressing portion 332 capable of pressing downwardly on one front end portion of the dissipating duct cover 710 forming the second discharge space 791.

As shown in FIG. 23, the at least one pressing portion may include a third pressing portion 333 capable of pressing downwardly on one front end portion of the dissipating duct cover 710 forming the intake space 752.

As shown in FIG. 24, the at least one pressing portion may include a fourth pressing portion 334 capable of pressing downwardly on a front end portion of the cover extension portion 715 of the dissipating duct cover 710.

Based on the left-right direction of the thermoelectric module assembly 450, the second pressing portion 332 and the third pressing portion 333 may press down the central portion, and the first pressing portion 331 and the fourth pressing portion 334 may press down both side portions, so that the front end portion of the thermoelectric module assembly 450 may be pressed down evenly throughout.

As such, as the top cover 300 presses the front end portion of the thermoelectric module assembly 450, movement of the thermoelectric module assembly 450 caused by the gap between the thermoelectric module assembly 450 and the upper surface of the main body 100, which is generated by a bulging phenomenon resulting from foaming, may be prevented or minimized.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A refrigerator, comprising:
a main body;
a storage compartment formed inside the main body;
a thermoelectric module assembly comprising:
a thermoelectric element comprising a heat generating portion and a heat absorbing portion,
a heat dissipating sink in contact with the heat generating portion,
a cooling sink in contact with the heat absorbing portion, and
a dissipating duct configured to dissipate heat from the heat dissipating sink, the thermoelectric module assembly being coupled to an upper portion of the main body to cool the storage compartment; and
a fastening member configured to pass through the thermoelectric module assembly to be coupled to the upper portion of the main body to couple the thermoelectric module assembly to the upper portion of the main body,
wherein the thermoelectric module assembly further comprises at least one support rib protruding downwardly to be supported on the upper portion of the main body at a position other than a position at which the fastening member is coupled.

2. The refrigerator of claim 1, wherein a position of the at least one support rib is further away from a central portion of an upper surface of the main body than a position of the fastening member.

3. The refrigerator of claim 1, wherein the at least one support rib comprises a first support rib protruding from a lower surface of the dissipating duct.

4. The refrigerator of claim 3, wherein the first support rib is formed on an edge portion of a lower surface of the dissipating duct.

5. The refrigerator of claim 3,
wherein the dissipating duct comprises a dissipating duct body, and a dissipating duct cover coupled to an upper portion of the dissipating duct body to form a dissipating flow path therebetween, and
wherein the first support rib protrudes from a lower surface of the dissipating duct body.

6. The refrigerator of claim 5,
wherein the dissipating duct body comprises a coupling hole through which the fastening member passes, and
wherein the first support rib is spaced apart from the coupling hole.

7. The refrigerator of claim 1, wherein the thermoelectric module assembly comprises a heat dissipation fan and a fan case, the heat dissipation fan being installed in the fan case.

8. The refrigerator of claim 7, wherein the at least one support rib further comprises a second support rib protruding from a lower surface of the fan case.

9. The refrigerator of claim 7,
wherein the thermoelectric module assembly further comprises a module plate,
wherein the thermoelectric element, the heat dissipating sink, and the cooling sink are installed on the module plate, and
wherein the fan case and the module plate are integrally formed.

10. The refrigerator of claim 1,
wherein the main body comprises:
an inner case forming the storage compartment
an outer case coupled to an outer side of the inner case, and
a connection frame disposed between the inner case and the outer case to form a through-hole in an upper wall of the main body, at least a portion of the thermoelectric module assembly being disposed within the through-hole, and
wherein the at least one fastening member passes through the thermoelectric module assembly and the outer case to be coupled to the connection frame.

11. The refrigerator of claim 1, further comprising:
a cushioning member disposed between the thermoelectric module assembly and an upper surface of the main body.

12. The refrigerator of claim 11, wherein the cushioning member comprises a foam sheet.

13. The refrigerator of claim 11, wherein the cushioning member is adhered to a lower surface of the dissipating duct.

14. The refrigerator of claim 1, further comprising:
a door configured to open or close the storage compartment;
a hinge configured to couple the door to the main body such that the door is rotatable; and
a top cover coupled to an upper surface of the main body to cover the hinge.

15. The refrigerator of claim 14, wherein the top cover is coupled to the upper surface of the main body such that the top cover presses at least a portion of the thermoelectric module assembly.
